(19) United States
(12) Patent Application Publication
(10) Pub. No.: US 2011/0217914 A1
(43) Pub. Date: Sep. 8, 2011

(54) VENTILATION NOZZLE FOR THE INTERIOR OF A VEHICLE

(75) Inventor: Andreas MARUTSCHKE, Ruesselsheim (DE)

(73) Assignee: GM GLOBAL TECHNOLOGY OPERATIONS LLC, Detroit, MI (US)

(21) Appl. No.: 13/040,502

(22) Filed: Mar. 4, 2011

(30) Foreign Application Priority Data
Mar. 5, 2010 (DE) 102010010399.3

(51) Int. Cl. B60H 1/34; B23P 19/00

(52) U.S. Cl. 454/152; 29/428

(57) ABSTRACT

A ventilation nozzle is provided for the interior of a motor vehicle comprising first and comprising second adjustable vanes for changing an air flow. The second vents are disposed downstream of the first vents and first and second vents are mounted so that they can be swiveled by means of a common control member in a casing of the nozzle. The control member is mounted swivelably downstream of the second vents.

### CROSS-REFERENCE TO RELATED APPLICATION

This application claims priority to German Patent Application No. 102010010399.3, filed Mar. 5, 2010, which is incorporated herein by reference in its entirety.

### TECHNICAL FIELD

The technical field relates to a ventilation nozzle for the interior of a motor vehicle comprising first and comprising second adjustable vanes for changing an air flow which can be supplied to the motor vehicle interior.

### BACKGROUND

Ventilation devices for motor vehicles are in particular configured to supply fresh air into the passenger compartment of the motor vehicle. As desired by the vehicle occupants, the temperature and the amount of air to be supplied can be variably adjusted by means of a heating or air conditioning module. The air intake into the passenger compartment is typically accomplished by means of a series of ventilation nozzles, which are let into the instrument panel, approximately at the height of the vehicle external mirrors, above the center console, and at further numerous locations in the motor vehicle interior.

In addition to an air control flap for throttling the supplied air, known ventilation nozzles also have a series of vanes disposed adjustably inside the ventilation nozzle, by which means the air outflow direction can be varied by the vehicle occupants as desired. Such a ventilation nozzle is disclosed, for example, in U.S. Pat. No. 6,159,092. This has two vane packages, which each comprise a number of vertically or horizontally aligned vanes. By means of a type of joystick, the vanes of one package can each be swiveled synchronously about an axis running in the longitudinal direction of the vanes. The actuating member provided for swiveling both vane packages comprises a ball joint, by which means the actuating member, when viewed in the flow direction of the air, is mounted between a vertically and a horizontally aligned vane.

By means of an extension projecting in the direction opposite to the direction of flow, the upstream vane package in the flow direction can be swiveled while the downstream vane package in the flow direction is guided in a shaft of the actuating member, which is slotted in the longitudinal direction.

Although both vane packages can be swiveled in the desired direction by means of the known actuating mechanism, the structure and the assembly of such a ventilation nozzle is configured to be complex and expensive. In this case, it is therefore necessary that the actuating member is already co-installed in a casing of the ventilation nozzle in the course of assembling the individual vane packages. In so doing, care must be taken to ensure that the actuating member is coupled in the manner provided both to the vertically and to the horizontally aligned vanes.

Since the interior design of a motor vehicle sometimes crucially influences the customer's decision to purchase, higher-quality materials such as brushed aluminum or walnut burl applications are being increasingly used in motor vehicle construction for fitting details of the passenger compartment. If the design of a ventilation nozzle is possibly also to be correspondingly variable, it would be advantageous if at least components hereof such as an actuating element or a front panel could be individually adapted to the customer's wishes in regard to material and/or shaping.

In this respect, it is at least one object to provide a ventilation nozzle for the interior of a motor vehicle, which is simplified in terms of production and assembly technology and consequently can be produced and assembled more cost-effectively. Furthermore, a ventilation nozzle should be particularly easily and universally adaptable to different interior designs of a motor vehicle. In addition, the ventilation nozzle should be characterized by a particularly attractive and elegant design as well as by functionality. In addition, other objects, desirable features and characteristics will become apparent from the subsequent summary and detailed description, and the appended claims, taken in conjunction with the accompanying drawings and this background.

### SUMMARY

A ventilation nozzle is provided for the interior of a motor vehicle. It comprises first and second adjustable vanes for changing an air flow. The second vents are disposed downstream of the first vents, first and second vents preferably forming a ventilation grid.

Typical configurations of first and second vents provide, for example, that the first vents run substantially in the vehicle transverse direction and the second vents run substantially in the vehicle vertical direction. Inverse configurations or alignments of the first and second vents differing from this are, however, equally within the scope of the invention. First and second vents are typically aligned substantially perpendicularly to one another. Depending on the design specification of the ventilation nozzle, however, it is also possible to deviate from this in favor of an approximately diamond-shaped configuration of a ventilation grid.

First and second vents are preferably adjustable synchronously with respect to one another, each in a type of vent package. That is, the first vents are, for example, connected to one another via a first coupling linkage, while the second vents are synchronized in movement with respect to one another by means of a second coupling linkage or the like means. It is further provided that first and second vents, that is that the first and the second vent packages, are mounted so that they can be swiveled by means of at least one common, preferably a single, control member in a casing of the nozzle. In this case, it proves to be advantageous if the control member is mounted swivelably on or in the ventilation nozzle downstream of the second vents. The mounting of the control member is consequently placed downstream of the vent grid, which enables easier assembly of the ventilation nozzle.

In addition, as a result of the arrangement of the control member downstream of the two vents in the flow direction, an adaptation of the ventilation nozzle or the control member to changing design specifications can be made particularly easily without the internal structure of the ventilation nozzle being affected by this. The mounting of the control member is located, when viewed by the vehicle occupant, ahead of the ventilation grid formed by the vents. From the assembly technology aspect, it is hereby provided that the control member is only mounted in the course of mounting the ventilation nozzle casing so that the mounting of the first and second vents can take place completely independently of the control member to be added subsequently. In this way, by providing different control member designs, the appearance of the ventilation nozzle can be adapted particularly simply and variably to the required installation situations by subsequently inserting or mounting the control member in a ventilation nozzle casing which always remains the same.

According to a first embodiment of the invention, it is provided that the control member is mounted in a receptacle located downstream of the second vents. In this case, the mounting for the control member is preferably configured as a casing component of the ventilation nozzle. The mounting forms a swivel or pivot point for the control member. This is located downstream of the second vents, consequently between the ventilation grid of the ventilation nozzle and the vehicle occupants.

According to a further embodiment of the invention, the control member has a control extension pointing in the direction opposite to the direction of flow, by which means the control member is operatively connected to the second and first vents. As a result of the swivelable or rotatable mounting of the control member at the receptacle, the control extension preferably executes a swiveling movement on actuating the control member, by which means both the first and the second vents can be swiveled in a predefined direction.

At the same time, it is provided in particular that the second vents have at least one control vent having a through opening for the control extension. The control vent is in direct operative communication with the remaining second vents disposed parallel hereto, preferably by means of a coupling rod, so that an adjusting movement transmitted to the control vent can be synchronously transmitted to the remaining second vents. Since the control extension of the control member passes through a through opening of the second control vent, the control member having the control extension can also be in direct operative communication with the control vent of the first vent package located upstream.

According to a further embodiment, it is thus provided that the first vanes have at least one control vent having a through opening, which is in operative communication with the control extension or comparably to the second control vent is penetrated by said control extension. It is preferable if the through openings in the first and/or the second control vent of first and/or second vent package are each configured in the manner of an elongate hole extending in the longitudinal direction of the vent. In this way, the control extension can swivel along the elongate-hole-like through opening without the relevant control vent being hereby exposed to a force acting in the longitudinal direction of the vent.

The through openings of first and/or second control vent can further have a predefined axial extension so that a swivel movement of the control extension of the actuating member directed transversely to the longitudinal direction of the vent can be converted into a corresponding swivel movement of the control vent. The control extension is substantially configured as a rectilinear pin, which passes through the two through openings of first and second control vent, which lie substantially in alignment to one another. Perpendicularly to its longitudinal extension, the through opening of the control vent has a clear width, which substantially corresponds to the diameter of the control extension. It can further be provided here that in order to minimize any movement play, the control extension abuts against the longitudinal side of the elongate openings.

According to a further embodiment, it can be provided that the elongate hole of the first and/or second control vent, when viewed in the direction of flow of the air, is disposed offset to the axis of rotation of the appurtenant control vent. In this way, the mutual contact surface of control extension and elongate hole inner wall can be reduced to a minimum, in order to keep movement-inhibiting frictional influences as low as possible.

In a further embodiment, it is provided inter alia that the receptacle for the control member is disposed on a frame located downstream of the second vents or is integrated in the frame. In this case, the frame can be configured as a casing component of the ventilation nozzle facing the vehicle interior. Here it is found to be advantageous if the control member is fastened already preassembled on the frame and by mounting the frame on the casing, the through openings of first and second control vent are penetrated by the control extension.

In this way, frames or control members varying in their surface design as desired by the customer, can be inserted into a prefabricated casing of a ventilation nozzle already fitted with vents. As a result of the mechanical coupling of control member and first and second vents, which only takes place as part of the mounting of the casing of the ventilation nozzle, the ventilation nozzle can be varied particularly simply to satisfy predefined design specifications without the actual mounting of the movably arranged vent packages being affected by this.

According to a further embodiment, it is provided that the receptacle has a dome-shaped contour and the control member has a spherical body configured to correspond to the receptacle. Receptacle and spherical body thus form a type of ball joint, which is disposed between ventilation grid and vehicle occupants, on a frame which surrounds or spans the ventilation grid at least in certain areas.

The spherical body of the control member is fixed on an appurtenant receptacle in the axial direction, that is viewed in the direction of flow. Such a fixing can be accomplished in particular by the spherical body and/or the receptacle being formed in two parts. In the case of a two-part receptacle, it can, for example, be provided that a retaining ring integrated in the frame has a clear inside diameter, which is smaller than the spherical radius of the control member. The sphere can be inserted into the retaining ring from behind, that is along the direction of flow. The dome-shaped receptacle adapted to the spherical geometry can then be connected to the retaining ring, possibly by screwing on or clipping on. Retaining ring and associated receptacle then form a swivelable mounting for the spherical body, which can optionally be provided with its section projecting through the retaining ring with an actuating member, for example, with a gripping or actuating surface.

It is further found that if the receptacle and/or the control member is provided with a sliding coating, possibly with a silicone surface, at least in some areas. Additionally or alternatively hereto, it can further be provided that the control extension or the elongate holes of the control vent in operative communication with said extension are provided with corresponding sliding coatings to reduce an actuating resistance.

The receptacle for the control member can be disposed approximately centrally in the area of the ventilation grid formed by the vent packages. In this case, the receptacle is preferably integrated in the frame of the casing which surrounds or spans the ventilation grid. The frame itself can, for example, surround the air outlet opening of the ventilation nozzle and have a web which extends transversely, perpendicularly, or obliquely over the ventilation grid, in or on which the receptacle for the spherical body or for the control member is formed. The frame, the web, and/or at least the visible parts of the actuating member can be formed from thermoplastic plastic and preferably as an injection-molded component. However, it is also feasible to form those components in metal, possibly in brushed aluminum, or as wood application in order to be able to individually adapt the design of the ventilation nozzle to the interior design of the vehicle.

According to a further embodiment, it is provided that the spherical body of the control member in the mounting position in the motor vehicle has an actuating surface facing the user. In this respect, it can be provided that the spherical body provides an actuation of the vent package based on a trackball. Thus, the vehicle occupants can possibly actuate the spherical body in the manner of a trackball and so bring about an adjusting movement for the vents.

According to a further embodiment it is hereby provided that the spherical body has at least one display and/or actuating means on the side facing away from the vents, consequently facing the vehicle occupants. For example, an elevation or indentation can be formed on that side of the spherical body, which is optionally identified by color or haptically. The position of that display means, which can equally well serve as an actuation aid, additionally indicates the alignment of the air flow to the vehicle occupant in a simple manner.

According to a further embodiment, a motor vehicle is provided having a ventilation nozzle according to the invention. Furthermore, a method is provided for mounting a ventilation nozzle for the interior of a motor vehicle. Here it is provided that a control member is disposed swivelably on a frame and by insertion or placement of the frame into or onto the casing of the nozzle having a control extension, comes into operative communication with first and second vanes disposed swivelably inside the casing. In particular, when viewed in the direction of flow, the frame is disposed downstream of the first and second vents on the casing of the ventilation nozzle and mounted on the casing of the ventilation nozzle with the control member premounted thereon in the direction opposite to the air flow direction.

### BRIEF DESCRIPTION OF THE DRAWINGS

The present invention will hereinafter be described in conjunction with the following drawing figures, wherein like numerals denote like elements, and:

FIG. 1 shows a perspective view of the two vent packages, the frame, and the control member mounted swivelably thereon;

FIG. 2 shows an exploded view of the ventilation nozzle according to FIG. 1;

FIG. 3 shows an isolated view of the two control vents in a first configuration;

FIG. 4 shows the control vents and the control member in a second configuration;

FIG. 5 shows the control vents according to FIG. 3 and FIG. 4 in a third swivel position; and

FIG. 6 shows a further embodiment with modified control member.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

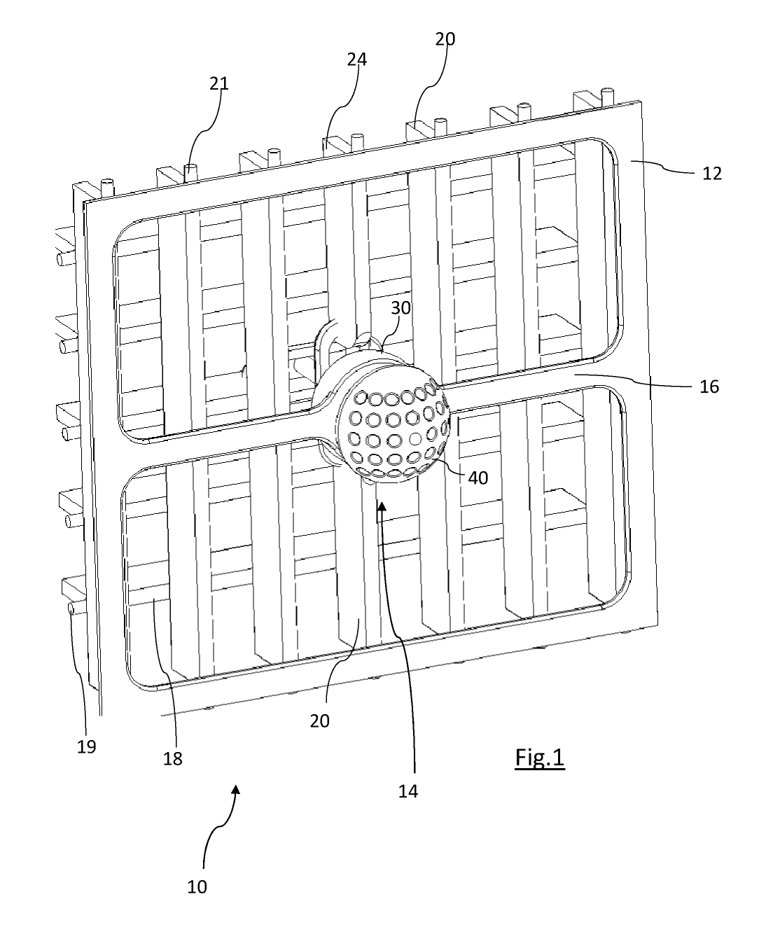

FIG. 1 shows in perspective view a ventilation nozzle 10, as viewed by a vehicle occupant from the interior of the vehicle. Here, however the components essential to the present invention are not shown explicitly for reasons of a simple functional representation.

The ventilation nozzle 10 comprises two vent packages, i.e., first, horizontally disposed vents 18 and second vertical vents 20 disposed downstream hereto. The horizontal vents 18 are swivelably mounted on the casing, not shown explicitly in the figures, by means of lateral extensions 19. The situation is similar with the second, vertical vents 20. These also have pin-like extensions 21 at both longitudinal ends, by means of which the vents 20 are swivelably mounted with respect to the casing. The vents pertaining to a vent package, that is the horizontal vents 18 taken alone and also the vertical vents 20 taken alone, are synchronized in movement by means of a coupling linkage likewise not shown explicitly.

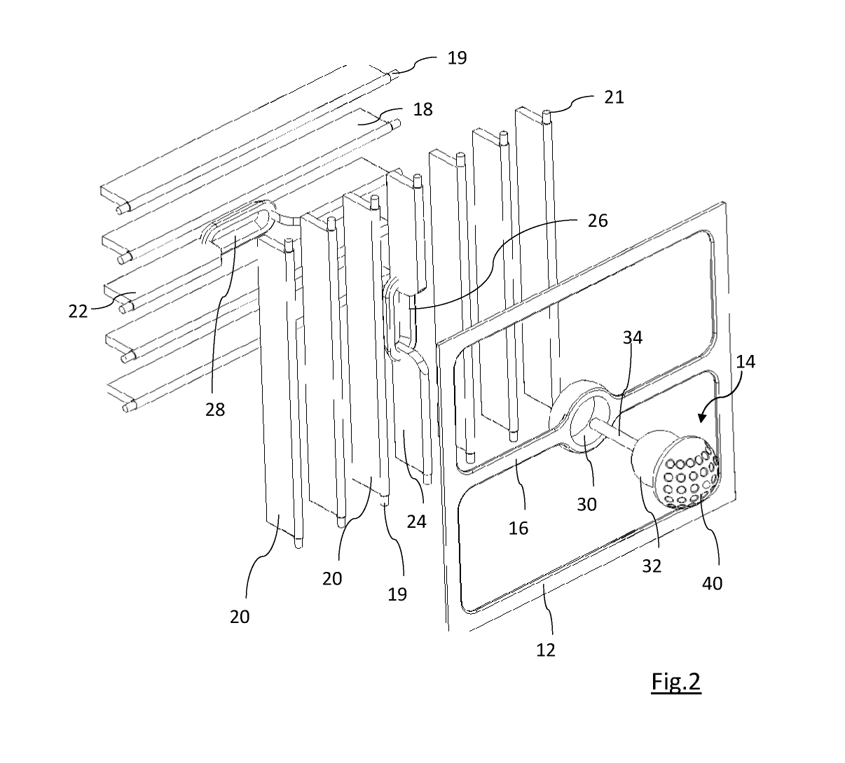

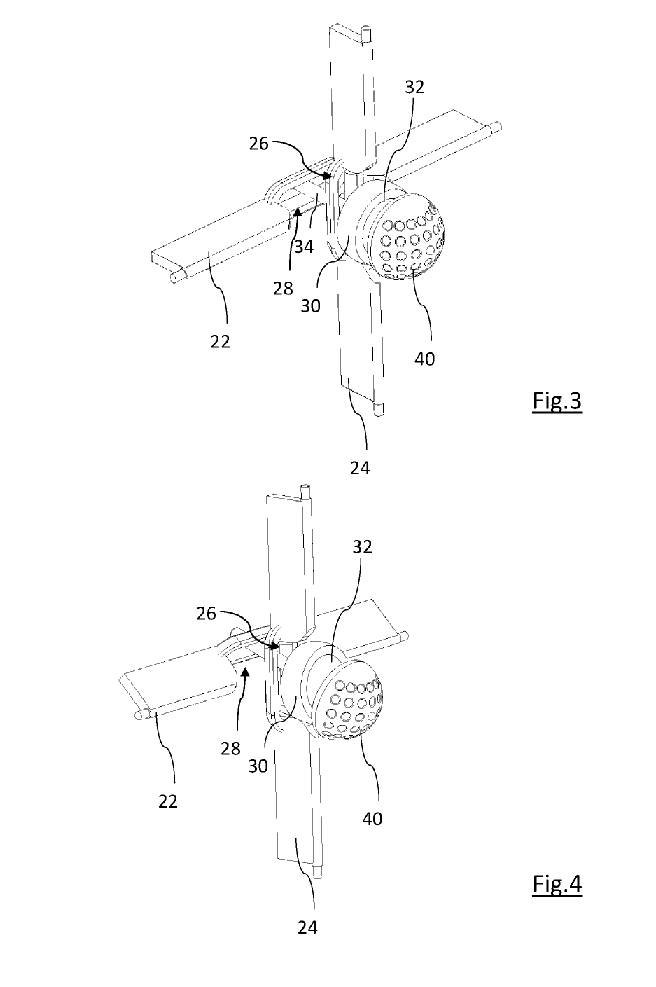

Each of the vent packages shown separately in FIG. 2 has a centrally disposed control vent 22 or 24. The control vent 22, 24 differs from the remaining vents 18, 20 disposed swivelably parallel thereto by means of an elongate hole 26, 28 extending in the longitudinal direction of the vents, which, when viewed in the direction of flow, is disposed offset with respect to the laterally protruding swivel pins 19, 21. The elongate holes 26, 28 of the two appurtenant control vents 24, 22 come to lie in alignment to one another, at least in some areas, as is illustrated in FIG. 3 to FIG. 5.

The elongate holes 26, 28 are provided here to receive a control extension 34, which passes through both elongate holes 26, 28 located one behind the other in the direction of flow. The control extension 34 is rigidly connected to a spherical body 32, 36, which is swivelably mounted in a receptacle 30. The receptacle 30 is in turn disposed downstream of the second, that is the vertical vent package 20. The swivel or mounting point of the control member 14 consequently lies downstream of the ventilation grid formed by the vents 18, 20, 22, 24.

The receptacle 30 for the control member 14 is in this case preferably integrated in a frame 12, which borders the ventilation grid at least in certain areas, which in the installation position on the vehicle, comes to lie between the actual ventilation grid and the vehicle occupant. The receptacle 30 for the control member 14 is in this case integrated approximately centrally in a transverse web 16 of the frame extending in the horizontal direction. The control member 14 is accordingly located approximately centrally in front of the ventilation grid formed by the vents 18, 20, 22, 24.

The receptacle 30 is preferably spherical-dome-shaped, so that the spherical body 32, viewed in the direction of flow, is fixed with respect to the frame 12. The dome-shaped receptacle 30 is advantageously formed in two parts so that the spherical body 32 can be inserted, for example, into a receiving ring let flush into or integrated in the transverse web 16 and can be fastened thereon with a dome-shaped closure on the rear side, that is facing the vents 20. In this case, the retaining ring let into the web 16 has a clear diameter that is smaller than the radius of the spherical body 32.

In FIG. 1 to FIG. 5, an attachment 40 provided with individual pimples is further fastened on the spherical body 32. The fastening of this attachment 40 is preferably carried out after mounting the spherical body 32 in the receptacle 30. The attachment 40 provided with pimples either fulfils predefined interior design requirements and/or provides an increased grip for the control member 14. The choice of material and surface condition of the attachment 40 should prevent any slippage of the actuating element.

FIG. 6 shows an alternative embodiment without actuating attachment 40. Here, the sphere 32 mounted in the receptacle 30 can be actuated directly by a user, possibly comparably to a trackball. The sphere 32 has an actuating surface 36 facing the user, in which either a further actuating element, possibly in the form of an elevation or recess 38, can be formed. At that point, the sphere 32 can additionally be marked in color or in some other way in order to visualize or identify in a haptically discernible manner the alignment of the vents and the associated alignment of the air flow.

FIG. 3 to FIG. 5 show different swivel positions of the control member 14. Starting from a neutral position according to FIG. 3, in which the vents 22, 24 are aligned substantially perpendicularly to one another, the control member 14 is pivoted downward in FIG. 4. Accordingly, the control extension 34 protruding into the vent packages and passing through the two through openings 26, 28 undergoes an upward swivel movement. This has the result that the control vent 22 mounted upstream in the flow direction swivels upward. Depending on the relative positioning of the elongate holes 26, 28 in relation to the pins or pivot points 19, 21 of the respective vents 20, 22, a corresponding air flow is produced, in the present case in FIG. 4 a downwardly directed air flow.

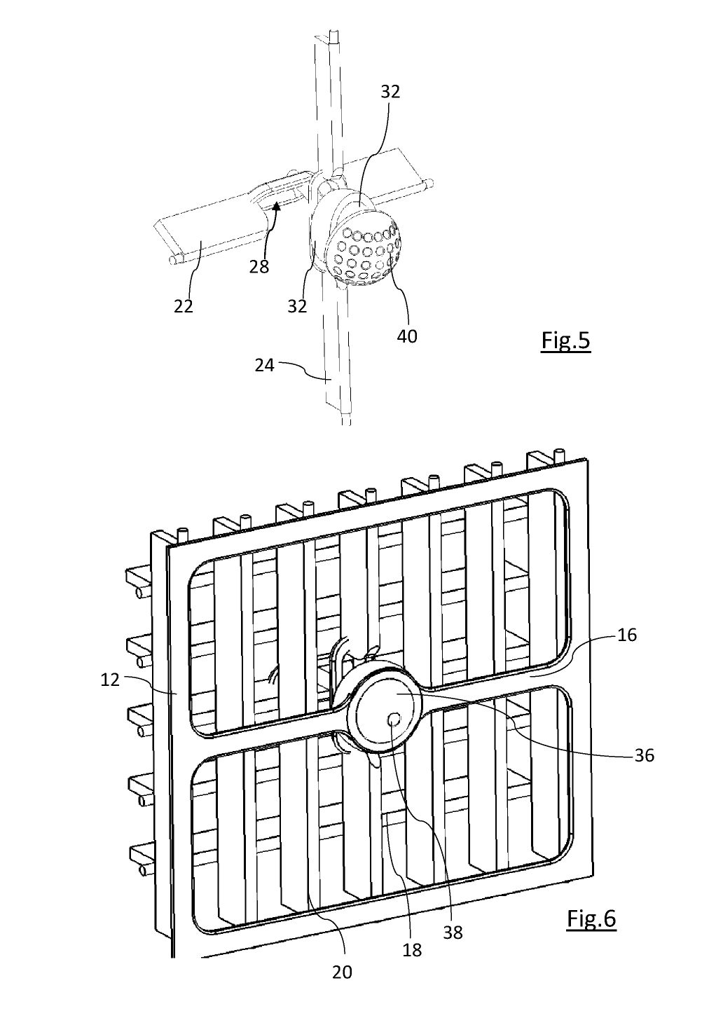

In FIG. 5 the control member 14 is additionally swiveled to the left, which causes a corresponding swivel movement of the vertical control vent 24. Due to the configuration of the elongate hole 28 provided in the horizontal control vent 22, the swivel position of the first control vent 22 remains largely untouched by this. The configuration shown in FIG. 5 consequently produces a leftward downwardly directed air flow.

The mounting of the ventilation nozzle can be simplified by the swivelable or rotatable arrangement of the control member 14 mounted upstream of the ventilation grid or mounted downstream in the direction of flow. For example, the control member 14 provided with the control extension 34 can be mounted preconfigured on the frame 12 before this is connected to the casing of the ventilation nozzle. The control member 14 only comes into the prescribed operative communication with the vents 18, 20, 22, 24, which are already disposed swivelably in the casing, in the course of a final assembly during which the frame 12 is fastened on the casing of the ventilation nozzle.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A ventilation nozzle for the interior of a motor vehicle, comprising:
a first vent configured to change an air flow;
a second vent configured to change the air flow, the second vent disposed downstream of the first vent; and
a control member in a casing of the ventilation nozzle mounted swivelably downstream of the second vent, the control member configured to swivel the first vent and the second vent.

2. The ventilation nozzle according to claim 1, wherein the control member is mounted in a receptacle located downstream of the second vent.

3. The ventilation nozzle according to claim 1, wherein the control member comprises a control extension pointing in a direction opposite to a direction of flow, the control extension operatively connecting the control member to the second vent and the first vent.

4. The ventilation nozzle according to claim 3, wherein the second vent comprises a control vent having a through opening that is penetrated by the control extension.

5. The ventilation nozzle according to claim 3, wherein the first vent comprises a control vent having a through opening that penetrated by the control extension.

6. The ventilation nozzle according to claim 4, wherein the through opening is an elongate hole extending in a longitudinal direction of the second vent.

7. The ventilation nozzle according to claim 5, wherein the through opening is an elongate hole extending in a longitudinal direction of the first vent.

8. The ventilation nozzle according to claim 2, wherein the receptacle is disposed on a frame located downstream of the second vent or is integrated in the frame.

9. The ventilation nozzle according to claim 2, wherein the receptacle has a dome-shaped contour and the control member has a spherical body configured to correspond to the receptacle.

10. The ventilation nozzle according to claim 9, wherein the receptacle is formed with a first part and a second part.

11. The ventilation nozzle according to claim 2, wherein the control member comprises a sliding coating.

12. The ventilation nozzle according to claim 2, wherein the receptacle comprises a sliding coating.

13. The ventilation nozzle according to claim 9, wherein the spherical body in a mounting position comprises an actuating surface facing a user.

14. The ventilation nozzle according to claim 9, wherein the spherical body comprises a display on a side facing away from the first vent and the second vent.

15. The ventilation nozzle according to claim 9, wherein the spherical body comprises an actuator on the side facing away from the first vent and the second vent.

16. A method for mounting a ventilation nozzle, comprising:
disposing a control member swivelably on a frame;
coupling the frame with a casing of the ventilation nozzle having a control extension in operative communication with a first vent and a second vent; and
disposing the first vent and the second vent swivelably inside the casing.

17. The method for mounting the ventilation nozzle according to claim 16, wherein the coupling comprises placing.

18. The method for mounting the ventilation nozzle according to claim 16, wherein the coupling comprises inserting.
